(19) United States
(12) Patent Application Publication
(10) Pub. No.: US 2002/0094409 A1
(43) Pub. Date: Jul. 18, 2002

(54) Process of manufacturing a plastic piece, corresponding fixing insert, and resultant piece

(76) Inventors: Pascal Query, Ronchamp (FR); Christophe Lyonnet, Montbeliard (FR)

Correspondence Address: YOUNG & THOMPSON, 745 SOUTH 23RD STREET 2ND FLOOR, ARLINGTON, VA, 22202

(21) Appl. No.: 09/983,195

(22) Filed: Oct. 23, 2001

(30) Foreign Application Priority Data
Oct. 24, 2000 (FR) 00 13643

(51) Int. Cl. B32B 7/08; B29C 70/78

(52) U.S. Cl. 428/99; 29/464; 24/711.5; 264/250; 264/255; 264/259

(57) ABSTRACT

In this method, in particular for manufacturing a piece of motor vehicle interior equipment comprising a main body (10) made of rigid plastic overmolded onto a coating (12) made of plastic, the coating (12) is manufactured, at least one orifice (32) is formed through the coating (12), a fixing insert (22) is pushed through the orifice (32), the insert is sealed (30, 36; 30, 70) to the coating, the fixing insert (22) is fixed to the coating, the coating (12) provided with fixing inserts (22) is placed in a mold, and the plastic of the main body (10) is overmolded onto the non-visible side of the coating (12), the solidified plastic immobilizing the insert.

The present invention relates to a method of manufacturing a plastic part, particularly a piece of motor vehicle interior equipment, the part comprising a main body made of rigid plastic and a coating made of plastic, the main body being overmolded onto the coating.

The state of the art knows dashboards for motor vehicles which comprise a basic body comprising several layers of plastic.

Usually, such a basic body comprises an outer coating consisting of a relatively soft layer possibly clad with a decorative skin, and a rigid interior layer which provides the basic body with stability. Manufacture of the basic body is by overmolding rigid material onto the outer coating.

Various components need to be fixed to the visible part of the dashboard, for example an instrument cluster.

These components are mounted as follows:

a cutout is made in the soft layer at the site where the component is to be fixed,

an orifice is pierced in the rigid layer,

a nut is placed on the non-visible part of the rigid layer, and

the component is fixed to the rigid layer by screw fastenings.

The periphery of the component needs to meet tolerances regarding the clearance and the flush-mounting with respect to the soft layer in the mounted state.

Because of the manufacturing tolerances on the soft layer, the situation may arise that the periphery of the component sits closer to or further away from the surface of the soft layer than permitted by the tolerances when this layer is thicker or thinner than anticipated at the fixing site. In addition, when the soft layer is thicker than anticipated, the periphery of the component may be too tight a fit against the soft layer, causing deformation of component or poor fixing thereof.

It is an object of the invention to alleviate the drawbacks and to propose a coated plastic part, particularly a piece of equipment for a motor vehicle, to which the components can be fixed observing the tolerances regarding clearances and flush-mounting customarily demanded with this type of product.

To this end, the subject of the invention is the method of the aforementioned type, characterized in that it comprises the following steps:

the coating is manufactured;

at least one orifice is formed through the coating, the location of this orifice corresponding to a location where a component will be fixed to the main body when the part is in the assembled state;

a fixing insert is pushed through the orifice, part of the insert projecting from the non-visible side of the coating;

the fixing insert is sealed to the coating with respect to the plastic material of the main body in the liquid state;

the fixing insert is fixed to the coating by temporary holding means;

the coating provided with the fixing insert is placed in a mold;

the mold is closed; and

the plastic of the main body is overmolded onto the non-visible side of the coating, the solidified plastic immobilizing the insert.

According to some particular embodiments of the invention, the method may involve one or more of the following characteristics:

the temporary holding means provide the said sealing;

the sealing means comprise a circular flange secured to the fixing insert which butts against the visible surface of the coating, and a complementary sealing member secured to the fixing insert on the non-visible side of the coating, the coating being gripped between the circular flange and the complementary member;

the insert is a plastically deformable bushing open on the visible side and the complementary sealing member is a bulge in the bushing obtained by axially upsetting it;

the complementary sealing member is an elastic sealing washer;

the orifice is formed in the coating by piercing and, prior to piercing, a centering element of a shape that complements the piercing tool is arranged at the site which corresponds to the orifice;

the centering element is formed integrally with the coating; and

the centering element is an end piece, particularly of conical exterior shape.

Another subject of the invention is a fixing insert for implementing a method as defined hereinabove, characterized in that it comprises, at one end, an exterior stop and, at the other end, a self-perforating portion for piercing the orifice.

This insert may have one or more of the following characteristics:

the self-perforating end is an externally cylindrical portion with an interior cavity and having a sharp edge at the point where the cylinder and the cavity intersect;

the fixing insert has, on its exterior surface, binding members, particularly some knurling; and

the insert comprises a hollow intermediate portion which can undergo plastic deformation by axial upsetting.

A further subject of the invention is a plastic part of the type comprising a main body made of rigid plastic, provided with a coating, the main body being overmolded onto the coating, and at least one insert for fixing a component to the part, characterized in that the fixing insert is as defined above, the exterior stop pressing against the visible surface of the coating and a portion of the insert passing through an orifice formed in the coating and projecting onto the non-visible side of the coating, this portion being coated with the rigid plastic of the main body.

According to particular embodiments, this part may have one or more of the following characteristics:

the fixing insert further comprises means for clamping the coating against the stop;

the part is a piece of motor vehicle interior equipment, particularly a dashboard, especially one equipped with a decorative coating.

The invention will be better understood from reading the description which will follow which is given solely by way of example and made with reference to the appended drawings in which:

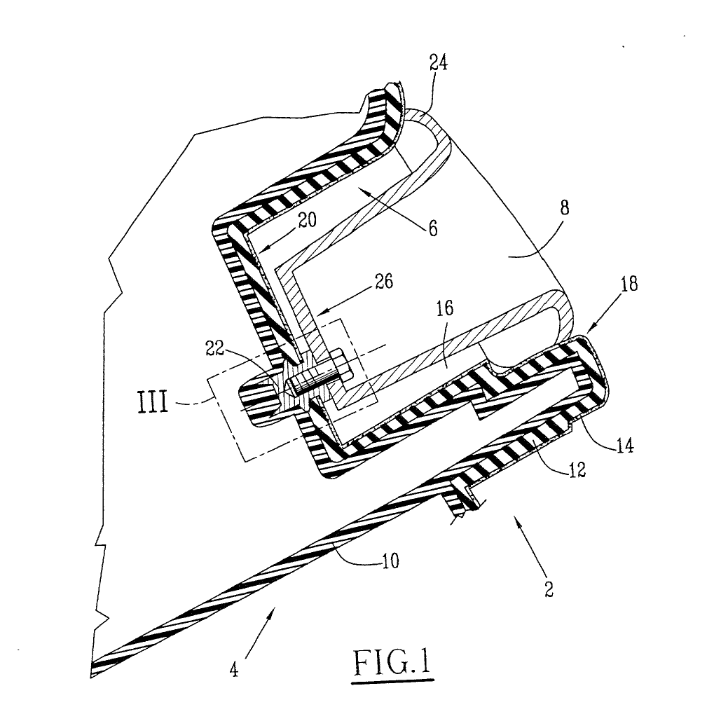

FIG. 1 is a schematic view in cross section of a first embodiment of a dashboard manufactured using the method according to the invention;

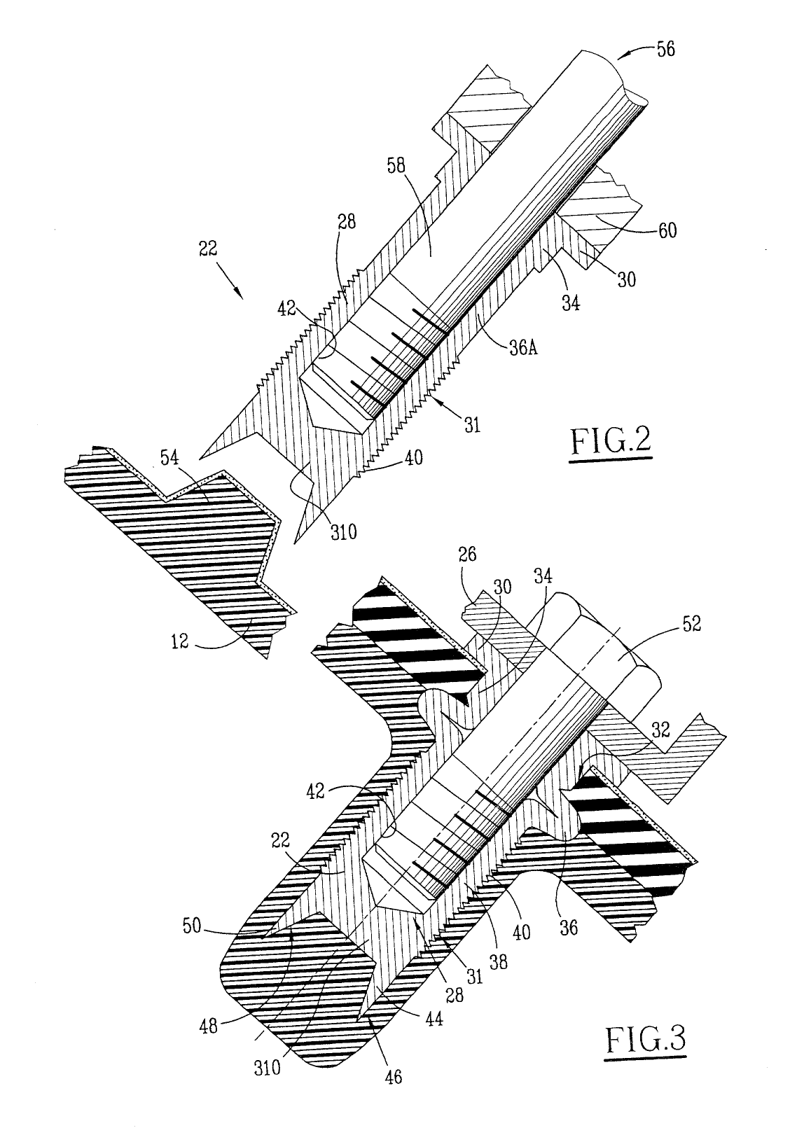

FIG. 2 is a schematic view in cross section of a detail of a coating and of a fixing insert;

FIG. 3 is a view of detail III of FIG. 1, on a large scale; and

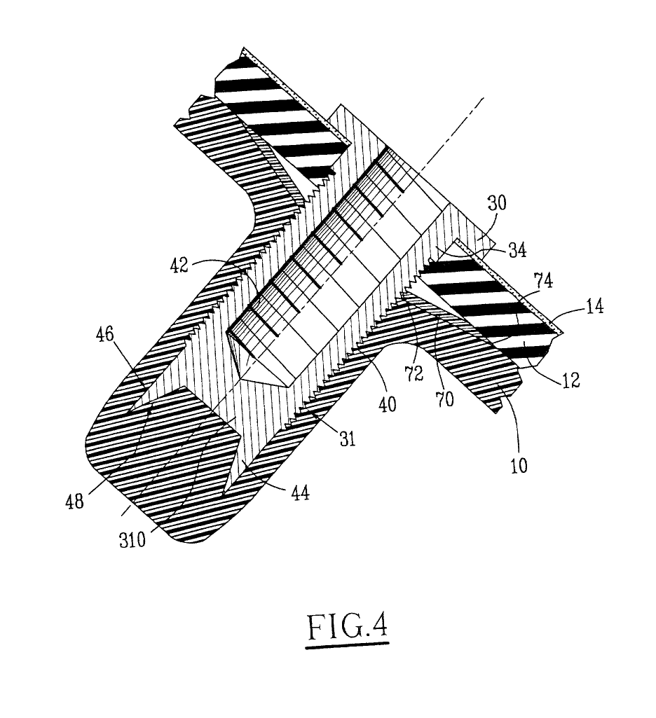

FIG. 4 is a detail view of a second embodiment of the dashboard according to the invention.

FIG. 1 depicts a sectional view of a first embodiment of a dashboard according to the invention, denoted by the general reference 2.

In what follows, the expression “visible” will denote the side facing toward the passenger, when the dashboard is in the mounted state, while the expression “non-visible” will denote the direction facing toward the inside of the dashboard.

The dashboard 2 comprises a base body 4 in which there is formed a housing 6 for a component 8, such as an instrument cluster.

The base body 4 comprises a main body 10 made of rigid plastic. The wall thickness of this main body 10 is typically from 2 mm to 6 mm.

The visible surface of the main body 10 is provided with a coating 12 of soft or semi-rigid plastic. As a preference, this coating has a thickness of between 1 mm and 4 mm. The coating 12 is provided with a decorative skin 14 on its visible surface.

To make the depiction clearer, the thickness of the layers are not drawn to scale in the figures.

The housing 6 of the component is delimited by a recess 16 formed in the dashboard 2. This recess 16 has a visible edge 18. Fixed into the bottom 20 of the recess is an insert 22 for fixing the component 8.

It can be seen that the component 8 is dish-shaped and has a rim 24 via which it rests against the edge 18 of the recess. The bottom 26 of the component is fixed to the insert 22.

FIG. 3 shows this fixing insert in greater detail

The fixing insert 22 consists mainly of a bushing 28 made of plastically deformable material, for example steel, copper, aluminum or plastic. When the bushing is made of plastic, this material has a melting point higher than that of the plastic of the main body 10. The bushing 28 is open toward the visible side and on its visible end bears a circular flange 30 which presses against the decorative skin 14. By contrast, the peripheral wall 31 of the bushing 28 and its opposite end 310 to the circular flange 30 are closed. The bushing 28 passes through an orifice 32 formed in the coating 12 and projects from the coating 12 on the non-visible side.

The bushing furthermore comprises a stepped part 34 of greater radial thickness which connects to the circular flange 30 and has an axial length shorter than the thickness of the coating 12 and of the decorative skin 14. A bulge 36 meets this stepped part 34 on the non-visible side and grips the coating 14 and the skin 12 against the circular flange 30, in a way which is sealed to the plastic of the main body 10 in the liquid state (see below) during overmolding.

A cylindrical part 38 meets this bulge 36 and has knurling 40 on its exterior surface and a tapped thread 42 on its interior surface.

The insert 22 ends at its non-visible end in a securing and self-piercing portion 44. This portion 44 has a cylindrical exterior surface 46 and a conical interior surface 48 which is open toward the non-visible side. These two surfaces form a circular cutting edge 50 for piercing on the non-visible end.

The edge 50 is used to pierce the orifice 32 in the coating 12 (see below) when the insert 22 is mounted on the coating 12, and to secure the insert 22 to the plastic of the main body 10.

When the part is in the finished state, as depicted in

FIG. 3, the portion 44, the cylindrical portion 38 and the non-visible side of the bulge 36 are covered with the plastic of the main body 10 and fix the fixing insert 22 thereto.

The bottom 26 of the component rests against the circular flange 30 and is fixed to the insert 22 by a screw 52 which is screwed into the tapped thread 42 of the insert.

FIG. 2 depicts the coating and the fixing insert 22 in the non-mounted state.

On its visible surface, the coating 12 has a frustoconical centering end piece 54 of a shape that complements the conical interior surface 48 of the fixing insert 22.

The portion 36A of the insert corresponding to the bulge 36 is not yet deformed and is in the form of a hollow cylinder with an outside diameter equal to that of the cylindrical portion 38 of the insert 22 in the mounted state.

The fixing insert 22 is mounted on a mounting tool 56 which comprises a threaded shank 58 screwed into the tapped thread 42 of the insert and a stop 60 in the form of a circular annulus. The threaded shank 58 is axially retractable with respect to the stop 60.

The dashboard according to the invention is manufactured as follows:

First of all, the coating 12 with the decorative skin 14 is manufactured, and is given a shape which corresponds roughly to the finished shape of the coating 12, for example by rotary molding or thermoforming. During this step, the centering end pieces 54 are also formed, and are formed as a single piece with the coating 12.

Next, the threaded shank 58 of the mounting tool 56 is screwed onto the fixing insert 22 until the stop 60 presses against the circular flange 30 (FIG. 2). In this configuration, the fixing insert 22 is turned together with the mounting tool 56. The self-piercing portion 44 of the insert 22 is applied to the centering end piece 54, the collaboration between the centering end piece 54 and the conical interior surface 48 centering the cutting edge 50 at the site desired for the orifice 32.

The edge 50 then cuts the orifice 32 from the skin 14 and the coating 12. Next, the fixing insert 22 is pushed into the orifice until the circular flange 30 presses against the decorative skin 14. The threaded shank 58 is retracted with respect to the stop 60, which upsets the cylindrical portion 36A, forming the bulge 36 and gripping the coating 12 and the skin 14 between this bulge and the circular flange.

The stepped part 34 of the fixing insert 22 presses against the wall of the orifice 32 and fixes the insert 22 additionally by friction.

The mounting tool 56 is unscrewed from the insert 22, and the coating 12 equipped with insert 22 is placed in a mold.

The circular flange 30 and the bulge 36 hold the insert 22 temporarily and prevent it from coming free from the coating 12.

The mold may be fitted with a holding rod which slips into the fixing insert 22 to assist with immobilizing the latter in the mold when the coating is not rigid enough.

Next, the mold is closed and liquid plastic is overmolded on the non-visible side of the coating 12. The liquid plastic coats the insert 22 on its cylindrical portion 38 and its securing portion 44, and on the non-visible portion of the bulge 36. Because the coating 12 is gripped between the bulge 36 and the circular flange 30, the orifice 32 is sealed against the liquid plastic, and this minimizes the risk that this plastic will penetrate to the visible side of the decorative skin 14.

The plastic is left to cure and the finished part is released from the mold. The insert 22 is completely immobilized by the rigid plastic, and the visible surface of the circular flange 30 is positioned with respect to the surface of the decorative skin 14 and with respect to the edge 18 of the recess.

The component 8 is then inserted into the recess 16 and screwed up against the circular flange 30 using the screw 52.

Given that the circular flange 30 is correctly positioned with respect to the edge 18 of the recess, the rim 24 of the component 8 presses against the edge 18 of the recess with less of a stand-off or a lesser degree of clamping.

FIG. 4 depicts a detail of a second embodiment of a dashboard manufactured by the method according to the invention, the component and the screw being omitted.

In what follows, only the differences with respect to the first embodiment will be described, elements which are same bearing the same references.

The fixing insert 22 has no bulge 36 for clamping against the coating 12 in the fixed state. By contrast, it is of roughly cylindrical exterior shape over roughly its entire length.

It has some circular knurling 40 on its exterior surface. The knurling 40 extends from the piercing end 44 up to the region which meets the stepped portion 34. Thus, the bit of knurling 40 adjacent to the stepped portion 34 presses against the surface of the orifice 32 and assists in holding the insert temporarily, through complementing shapes.

Furthermore, a holding and sealing washer 70 is slipped over the fixing insert 22 on the non-visible side.

This washer 70 is made of a plastic which has a melting point higher than that of the plastic of the main body 10. It is, for example, made of thermoplastic or of hard elastomer.

The washer 70 has the shape of a Belleville washer. In the non-mounted state, the diameter of its interior edge 72 is slightly smaller than the small diameter of the knurling 40. In the mounted state, it is gripped in a sealed fashion against the bottom of the knurling 40. The exterior edge 74 of the washer 70 presses against the non-visible surface of the coating 12, this also being in a sealed fashion.

This fixing insert is mounted as follows:

The orifice 32 is cut from the coating 12 using the insert 22, and the latter is pushed into this orifice 32 in a similar way to the first embodiment.

Next, the washer 70 is slipped onto the non-visible portion of the insert 22 until the exterior edge 74 of the washer 70 presses against the coating 12. Next, the mounting tool 56 is unscrewed without upsetting the insert 22.

The insert 22 is held temporarily by the clamping performed by the washer 70 and the circular flange 30, and by friction by the stepped part 34 and by complementing shapes by virtue of the knurled portion 40.

The overmolding and the mounting of the component 8 are then performed in a similar way to the first embodiment. The washer 70 seals against the liquid plastic during overmolding.

It is found that the method according to the invention allows the fixing inserts to be fixed to the plastic part without the operation of cutting through the coating and the decorative skin, thus leading to a low cost of manufacture.

1. Method of manufacturing a plastic part, particularly a piece of motor vehicle interior equipment, the part (2) comprising a main body (10) made of rigid plastic and a coating (12) made of plastic, the main body (10) being overmolded onto the coating (12), characterized in that it comprises the following steps:
the coating (12) is manufactured;
at least one orifice (32) is formed through the coating (12), the location of this orifice (32) corresponding to a location where a component (6) will be fixed to the main body (10) when the part (2) is in the assembled state;
a fixing insert (22) is pushed through the orifice (32), part of the insert projecting from the non-visible side of the coating (12);
the fixing insert (22) is sealed (30, 36; 30, 70) to the coating (12) with respect to the plastic material of the main body (10) in the liquid state;
the fixing insert (22) is fixed to the coating by temporary holding means (30, 36; 30, 70);
the coating (12) provided with the fixing insert (22) is placed in a mold;
the mold is closed; and
the plastic of the main body (10) is overmolded onto the non-visible side of the coating (12), the solidified plastic immobilizing the insert.

2. Method according to claim 1, characterized in that the temporary holding means (30, 36; 30, 70) provides the said sealing.

3. Method according to claim 1 or 2, characterized in that the sealing means (30, 36; 30, 70) comprise a circular flange (30) secured to the fixing insert (22) which butts against the visible surface of the coating (12), and a complementary sealing member (36; 70) secured to the fixing insert (22) on the non-visible side of the coating (12), the coating (12) being gripped between the circular flange (30) and the complementary member.

4. Method according to claim 3, characterized in that the insert is a plastically deformable bushing open on the visible side and in that the complementary sealing member is a bulge (36) in the bushing obtained by axially upsetting it.

5. Method according to claim 3, characterized in that the complementary sealing member is an elastic sealing washer (70).

6. Method according to any one of claims 1 to 5, characterized in that the orifice (32) is formed in the coating (12) by piercing and in that, prior to piercing, a centering element (54) of a shape that complements the piercing tool is arranged at the site which corresponds to the orifice (32).

7. Method according to claim 6, characterized in that the centering element (54) is formed integrally with the coating (12).

8. Method according to claim 6 or 7, characterized in that the centering element (54) is an end piece, particularly of conical exterior shape.

9. Fixing insert for implementing a method according to any one of claims 1 to 8, characterized in that it comprises, at one end, an exterior stop (30) and, at the other end, a self-perforating portion (44) for piercing the orifice (32).

10. Insert according to claim 9, characterized in that the self-perforating end (44) is an externally cylindrical portion (46) with an interior cavity (48) and having a sharp edge (50) at the point where the cylinder (46) and the cavity (48) intersect.

11. Insert according to claim 9 or 10, characterized in that the fixing insert (22) has, on its exterior surface, binding members, particularly some knurling.

12. Insert according to any one of claims 9 to 11, characterized in that it comprises a hollow intermediate portion (36A) which can undergo plastic deformation by axial upsetting.

13. Insert according to any one of claims 9 to 11, characterized in that it comprises an elastic washer (70) that can be positioned along the insert.

14. Plastic part of the type comprising a main body (10) made of rigid plastic, provided with a coating (12), the main body (10) being overmolded onto the coating (12), and at least one insert (22) for fixing a component (8) to the part, characterized in that the fixing insert (22) is in accordance with any one of claims 9 to 13, the exterior stop (30) pressing against the visible surface of the coating and a portion (38, 44) of the insert passing through an orifice (32) formed in the coating (12) and projecting onto the non-visible side of the coating (12), this portion (38, 44) being coated with the rigid plastic of the main body (10).

15. Part according to claim 14, characterized in that the fixing insert (22) further comprises means (36; 70) for clamping the coating (12) against the stop (30).

16. Part according claim 14 or 15, characterized in that the part is a piece of motor vehicle interior equipment, particularly a dashboard (2), especially one equipped with a decorative coating (14).
